(19) United States
(12) Patent Application Publication
(10) Pub. No.: US 2011/0179390 A1
(43) Pub. Date: Jul. 21, 2011

(54) METHODS, SYSTEMS, AND COMPUTER PROGRAM PRODUCTS FOR TRAVERSING NODES IN PATH ON A DISPLAY DEVICE

(76) Inventor: Robert Paul Morris, Raleigh, NC (US)

(21) Appl. No.: 12/688,996

(22) Filed: Jan. 18, 2010

(51) Int. Cl. G06F 3/048

(52) U.S. Cl. 715/854

(57) ABSTRACT

Methods and systems are described for traversing nodes in path on a display device. In one aspect methods and systems include, detecting a first navigation input from a user. Determining a first path including a first plurality of nodes in a hierarchy. In response to the first navigation input, traversing the first path by providing for sequentially presenting in time, by a display device, first visual representations of the nodes in the first path, the first visual representations indicating corresponding current locations during the traversing.

### RELATED APPLICATIONS

This application is related to the following commonly owned U.S. patent applications, the entire disclosure of each being incorporated by reference herein: application Ser. No. ______ (Docket No 0080) filed on ______ entitled “Methods, Systems, and Program Products for Automatically Selecting Objects in a Plurality of Objects”; and

application Ser. No. ______ (Docket No 0093) filed on ______ entitled “Methods, Systems, and Program Products for Automating Operations on a Plurality of Objects”.

### BACKGROUND

Graphical user interfaces (GUIs) have changed the way users interact with electronic devices. In particular, GUIs have made navigation of large amounts of data much easier. For example, users can use point-and-click interfaces to browse file systems and other hierarchical structures. Prior to GUIs a user had to know where a needed file was located in a file system and look up or remember a string to type in to identify the file's absolute location in the file system or relative location from a current location. If the user didn't know the location of the file, the user had to know and enter numerous commands to change and list the contents of various directories as s/he searched for the file.

GUI navigation applications no longer, typically, require users to type in commands or file locations, although both remain options. Navigation is performed by repeating a series of user inputs, such as a series of clicks on folder icons and/or clicks on “back” and/or “up” GUI controls. Despite the fact that electronic devices have automated many user tasks; navigation of hierarchical structures remains a task requiring users to repeatedly provide navigation input. This not only can be tedious for some users, it can lead to health problems as the current incidence of repetitive motion disorders indicates.

One technology currently in use that helps to limit the number of user inputs required to locate an object includes links of various types known as “shortcuts” in some contexts. Shortcuts and analogs of shortcuts are most helpful when a user knows the location s/he wants or needs to navigate to and wants to go there directly. For media including videos and images, users can automatically navigate a sequence of images (e.g. stills and/or frames in video) with a single input. Media players typically include fast-forward GUI controls and even a play GUI control that when activated initiates automatic browsing of a video's frames. Image slideshow players are perhaps a more easily understandable example.

Nevertheless, navigation of hierarchical structures remains user-input-intensive and manual. Accordingly, there exists a need for methods, systems, and computer program products for reducing the need for repeated input in traversing nodes in path on a display device.

### SUMMARY

The following presents a simplified summary of the disclosure in order to provide a basic understanding to the reader. This summary is not an extensive overview of the disclosure and it does not identify key/critical elements of the invention or delineate the scope of the invention. Its sole purpose is to present some concepts disclosed herein in a simplified form as a prelude to a more detailed description that is presented later.

Methods and systems are described for traversing nodes in path on a display device. In one aspect the method includes, detecting a first navigation input from a user. The method further includes determining a first path including a first plurality of nodes in a hierarchy. The method still further includes, in response to the first navigation input, traversing the first path by providing for sequentially presenting in time, by a display device, first visual representations of the nodes in the first path, the first visual representations indicating corresponding current locations during the traversing.

Further, a system for traversing nodes in path on a display device is described. The system includes a navigation controller component configured for detecting a first navigation input from a user. The system further includes a path selector component configured for determining a first path including a first plurality of nodes in a hierarchy. The system still further includes a node user interface element handler component configured for, in response to the first navigation input, traversing the first path by providing for sequentially presenting in time, by a display device, first visual representations of the nodes in the first path, the first visual representations indicating corresponding current locations during the traversing.

In another aspect, a method for traversing nodes in path on a display device is described that includes sending start representation information representing a start node, included in a hierarchy of nodes, for presenting, based on the start representation information, a start visual representation of the start node by a display device. The method further includes detecting a navigation input for traversing a path of nodes in the hierarchy including a first path node and second path node, the path determined based on the start node. The method still further includes, in response to detecting the navigation input, traversing the path including sending first path representation information representing the first path node for presenting, based on the first path representation information, a first path visual representation of the first path node by the display device in place of the start visual representation. The method also includes automatically sending second path representation information representing the second path node for presenting, based on the second path representation information, a second path visual representation of the second path node by the display device in place of the first path visual representation.

Still further, a system for traversing nodes in path on a display device is described that includes a node user interface element handler component configured for sending start representation information representing a start node, included in a hierarchy of nodes, for presenting, based on the start representation information, a start visual representation of the start node by a display device is described. The system includes a navigation controller component configured for detecting a navigation input for traversing a path of nodes in the hierarchy including a first path node and second path node, the path determined based on the start node. The system still further includes a path selector component configured for, in response to detecting the navigation input, traversing the path including sending first path representation information representing the first path node for presenting, based on the first path representation information, a first path visual representation of the first path node by the display device in place of the start visual representation automatically sending second path representation information representing the second path node for presenting, based on the second path representation information, a second path visual representation of the second path node by the display device in place of the first path visual representation.

### BRIEF DESCRIPTION OF THE DRAWINGS

Objects and advantages of the present invention will become apparent to those skilled in the art upon reading this description in conjunction with the accompanying drawings, in which like reference numerals have been used to designate like or analogous elements, and in which:

FIG. 1 is a block diagram illustrating an exemplary hardware device included in and/or otherwise providing an execution environment in which the subject matter may be implemented;

FIG. 2 is a flow diagram illustrating a method for traversing nodes in path on a display device according to an aspect of the subject matter described herein;

FIG. 3 is block a diagram illustrating an arrangement of components for traversing nodes in path on a display device according to another aspect of the subject matter described herein;

FIG. 4 is a block a diagram illustrating an arrangement of components for traversing nodes in path on a display device according to an aspect of the subject matter described herein;

FIG. 5 is block a diagram illustrating an arrangement of components for traversing nodes in path on a display device according to another aspect of the subject matter described herein;

FIG. 6 is a network diagram illustrating an exemplary system for traversing nodes in path on a display device according to an aspect of the subject matter described herein;

FIG. 7 is a diagram illustrating a user interface presented by a display according to an aspect of the subject matter described herein; and

FIG. 8 is a flow diagram illustrating a method for traversing nodes in path on a display device according to an aspect of the subject matter described herein.

### DETAILED DESCRIPTION

Prior to describing the subject matter in detail, an exemplary device included in an execution environment that may be configured according to the subject matter is described. An execution environment is a configuration of hardware and, optionally, software that may be further configured to include an arrangement of components for performing a method of the subject matter described herein.

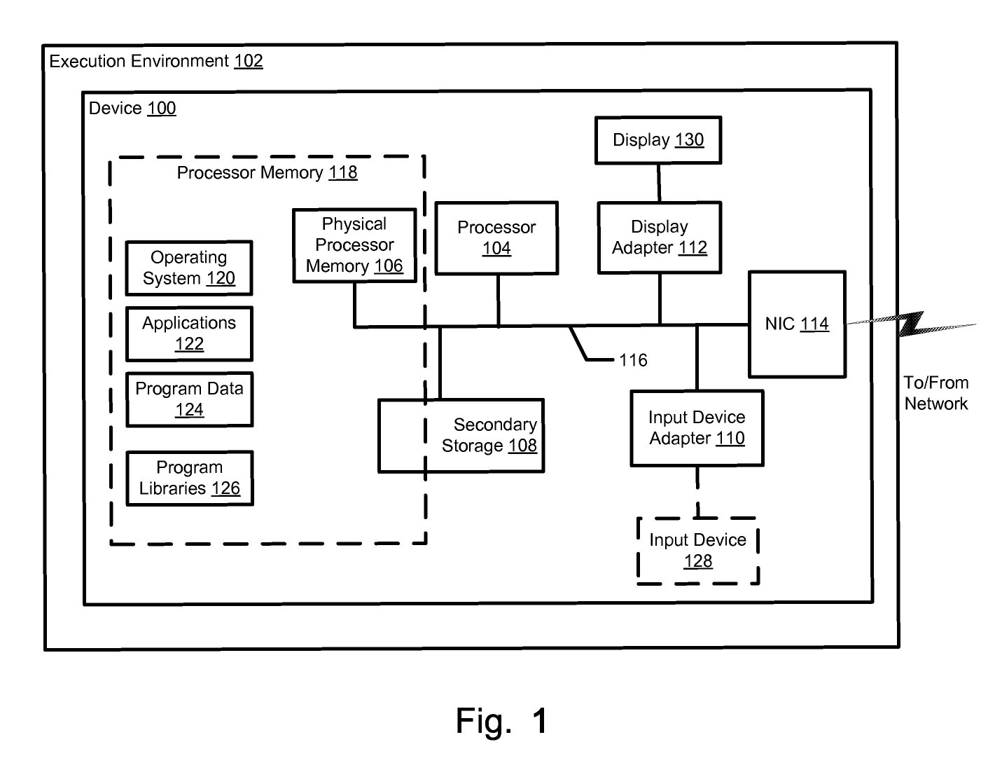

Those of ordinary skill in the art will appreciate that the components illustrated in FIG. 1 may vary depending on the execution environment implementation. An execution environment includes or is otherwise provided by a single device or multiple devices, which may be distributed. An execution environment typically includes both hardware and software components, but may be a virtual execution environment including software components operating in a host execution environment. Exemplary devices included in or otherwise providing suitable execution environments for configuring according to the subject matter include personal computers, servers, hand-held and other mobile devices, multiprocessor systems, consumer electronic devices, and network-enabled devices such as devices with routing and/or switching capabilities.

With reference to FIG. 1, an exemplary system for configuring according to the subject matter disclosed herein includes hardware device 100 included in execution environment 102. Device 100 includes an instruction processing unit illustrated as processor 104, physical processor memory 106 including memory locations that are identified by a physical address space of processor 104, secondary storage 108, input device adapter 110, a presentation adapter for presenting information to a user illustrated as display adapter 112, a communication adapter for communicating over a network such as network interface card (NIC) 114, and bus 116 that operatively couples elements 104-114.

Bus 116 may comprise any type of bus architecture. Examples include a memory bus, a peripheral bus, a local bus, a switching fabric, etc. Processor 104 is an instruction execution machine, apparatus, or device and may comprise a microprocessor, a digital signal processor, a graphics processing unit, an application-specific integrated circuit (ASIC), a field programmable gate array (FPGA), etc.

Processor 104 may be configured with one or more memory address spaces in addition to the physical memory address space. A memory address space includes addresses that identify corresponding locations in a processor memory. An identified location is accessible to a processor processing an address that is included in the address space. The address is stored in a register of the processor and/or identified in an operand of a machine code instruction executed by the processor.

FIG. 1 illustrates that processor memory 118 may have an address space including addresses mapped to physical memory addresses identifying locations in physical processor memory 106. Such an address space is referred to as a virtual address space, its addresses are referred to as virtual memory addresses, and its processor memory is known as a virtual processor memory. A virtual processor memory may be larger than a physical processor memory by mapping a portion of the virtual processor memory to a hardware memory component other than a physical processor memory. Processor memory 118 illustrates a virtual processor memory mapped to physical processor memory 106 and to secondary storage 108. Processor 104 may access physical processor memory 106 without mapping a virtual memory address to a physical memory address.

Thus at various times, depending on the address space of an address processed by processor 104, the term processor memory may refer to physical processor memory 106 or a virtual processor memory as FIG. 1 illustrates.

Program instructions and data are stored in physical processor memory 106 during operation of execution environment 102. In various embodiments, physical processor memory 106 includes one or more of a variety of memory technologies such as static random access memory (SRAM) or dynamic RAM (DRAM), including variants such as dual data rate synchronous DRAM (DDR SDRAM), error correcting code synchronous DRAM (ECC SDRAM), or RAMBUS DRAM (RDRAM), for example. Processor memory may also include nonvolatile memory technologies such as nonvolatile flash RAM (NVRAM), ROM, or disk storage. In some embodiments, it is contemplated that processor memory includes a combination of technologies such as the foregoing, as well as other technologies not specifically mentioned.

In various embodiments, secondary storage 108 includes one or more of a flash memory data storage device for reading from and writing to flash memory, a hard disk drive for reading from and writing to a hard disk, a magnetic disk drive for reading from or writing to a removable magnetic disk, and/or an optical disk drive for reading from or writing to a removable optical disk such as a CD ROM, DVD or other optical media. The drives and their associated computer-readable media provide volatile and/or nonvolatile storage of computer readable instructions, data structures, program components and other data for the execution environment 102. As described above, when processor memory 118 is a virtual processor memory, at least a portion of secondary storage 108 is addressable via addresses within a virtual address space of the processor 104.

A number of program components may be stored in secondary storage 108 and/or in processor memory 118, including operating system 120, one or more applications programs (applications) 122, program data 124, and other program code and/or data components as illustrated by program libraries 126.

Execution environment 102 may receive user-provided commands and information via input device 128 operatively coupled to a data entry component such as input device adapter 110. An input device adapter may include mechanisms such as an adapter for a keyboard, a touch screen, a pointing device, etc. An input device included in execution environment 102 may be included in device 100 as FIG. 1 illustrates or may be external (not shown) to the device 100. Execution environment 102 may support multiple internal and/or external input devices. External input devices may be connected to device 100 via external data entry interfaces supported by compatible input device adapters. By way of example and not limitation, external input devices may include a microphone, joystick, game pad, satellite dish, scanner, or the like. In some embodiments, external input devices may include video or audio input devices such as a video camera, a still camera, etc. Input device adapter 110 receives input from one or more users of execution environment 102 and delivers such input to processor 104, physical processor memory 106, and/or other components operatively coupled via bus 116.

Output devices included in an execution environment may be included in and/or external to and operatively coupled to a device hosting and/or otherwise included in the execution environment. For example, display 130 is illustrated connected to bus 116 via display adapter 112. Exemplary display devices include liquid crystal displays (LCDs), light emitting diode (LED) displays, and projectors. Display 130 presents output of execution environment 102 to one or more users. In some embodiments, a given device such as a touch screen functions as both an input device and an output device. An output device in execution environment 102 may be included in device 100 as FIG. 1 illustrates or may be external (not shown) to device 100. Execution environment 102 may support multiple internal and/or external output devices. External output devices may be connected to device 100 via external data entry interfaces supported by compatible output device adapters. External output devices may also be connected to bus 116 via internal or external output adapters. Other peripheral output devices, not shown, such as speakers and printers, tactile, and motion producing devices may be connected to device 100. As used herein the term display includes image projection devices.

A device included in or otherwise providing an execution environment may operate in a networked environment using logical connections to one or more devices (not shown) via a communication interface. The terms communication interface and network interface are used interchangeably. Device 100 illustrates network interface card (NIC) 114 as a network interface included in execution environment 102 to operatively couple execution environment 102 to a network.

A network interface included in a suitable execution environment, such as NIC 114, may be coupled to a wireless network and/or a wired network. Examples of wireless networks include a BLUETOOTH network, a wireless personal area network (WPAN), a wireless 702.11 local area network (LAN), and/or a wireless telephony network (e.g., a cellular, PCS, or GSM network). Examples of wired networks include a LAN, a fiber optic network, a wired personal area network, a telephony network, and/or a wide area network (WAN). Such networking environments are commonplace in intranets, the Internet, offices, enterprise-wide computer networks and the like. In some embodiments, NIC 114 or a functionally analogous component includes logic to support direct memory access (DMA) transfers between processor memory 118 and other devices.

In a networked environment, program components depicted relative to execution environment 102, or portions thereof, may be stored in a remote storage device, such as, on a server. It will be appreciated that other hardware and/or software to establish a communications link between the device illustrated by device 100 and other network devices may be included.

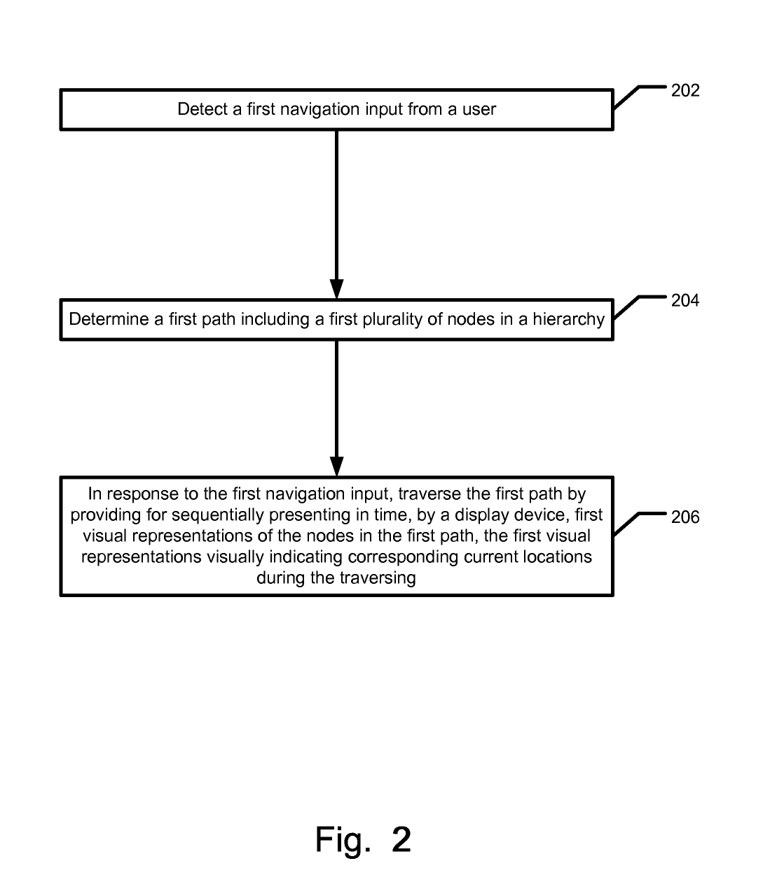

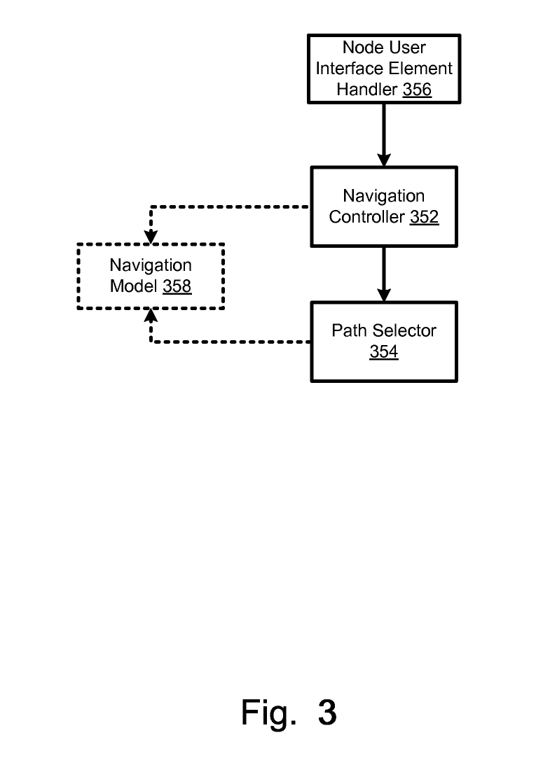

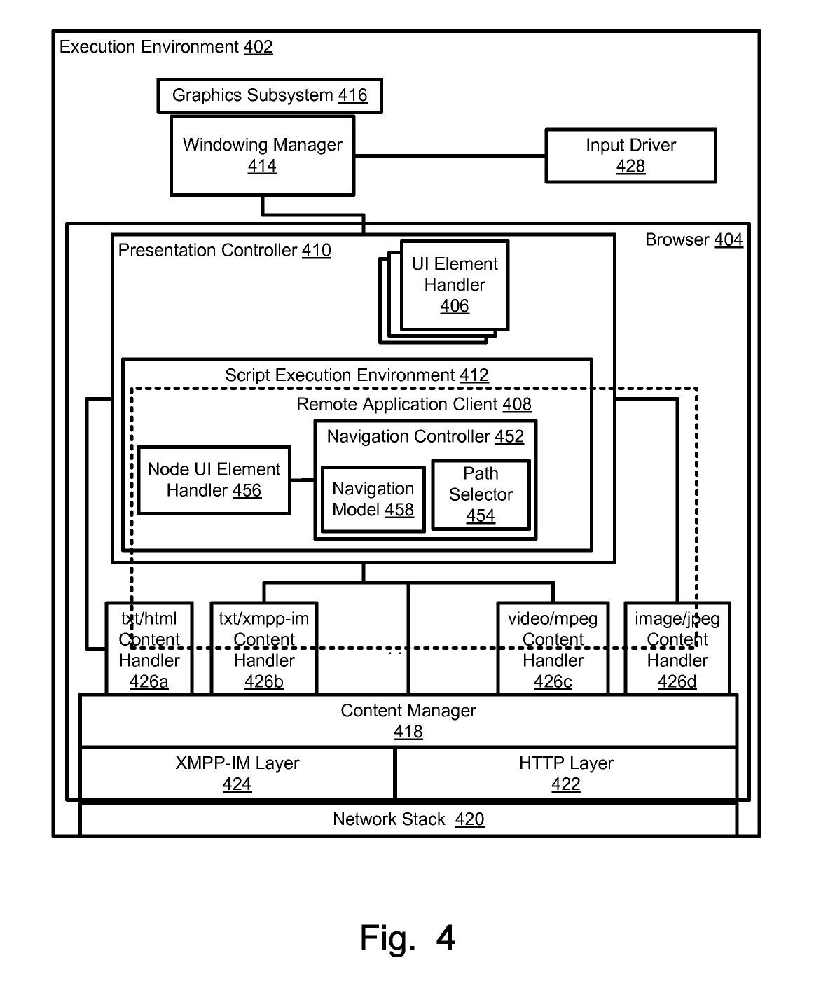

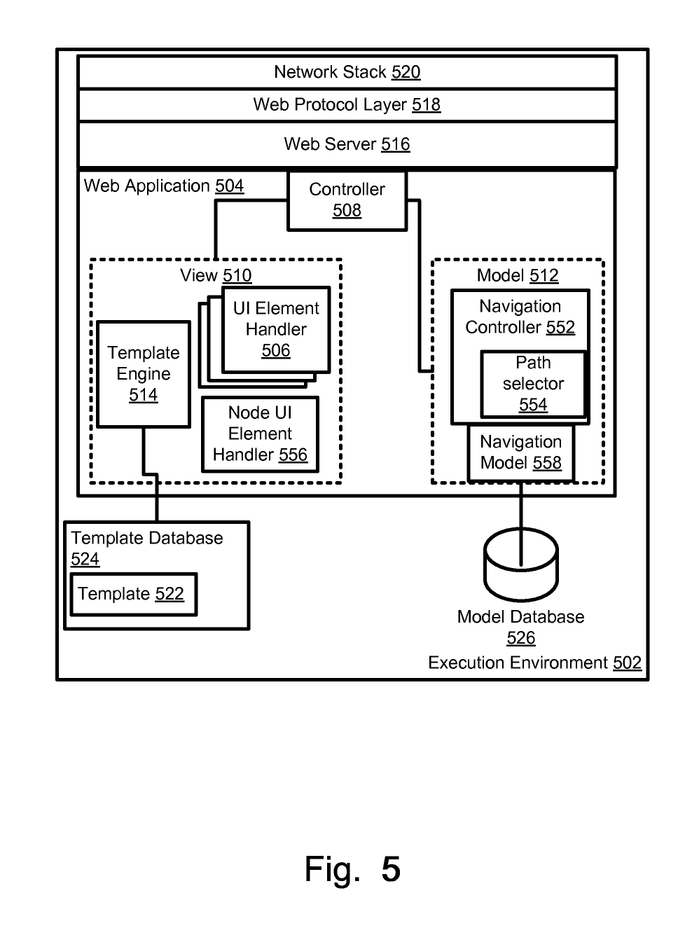

FIG. 2 is a flow diagram illustrating a method for traversing nodes in path on a display device according to an exemplary aspect of the subject matter described herein. FIG. 3 is a block diagram illustrating a system for traversing nodes in path on a display device according to another exemplary aspect of the subject matter described herein. FIG. 4 and FIG. 5 are block diagrams each illustrating the components of FIG. 3 and/or analogs of the components of FIG. 3 adapted for operation in an execution environment including or otherwise provided by one or more devices. The method depicted in FIG. 2 may be carried out by some or all of the exemplary arrangements and their analogs. The illustrated arrangements and/or their analogs may include and/or otherwise interoperate with some or all of the components of FIG. 1 and/or analogs of the components of FIG. 1.

The components illustrated in FIG. 3 may be adapted for performing the method illustrated in FIG. 2 in a number of execution environments. Adaptations of the components illustrated in FIG. 3 for performing the method illustrated in FIG. 2 are described operating in exemplary execution environment 402, illustrated in FIG. 4 including browser 404 application, and in exemplary execution environment 502, illustrated in FIG. 5 including web application 504. FIG. 1 illustrates key components of an exemplary device that may at least partially provide and/or otherwise be included in an exemplary execution environment, such as those illustrated in FIG. 4 and FIG. 5. The components illustrated in FIG. 3, FIG. 4, and FIG. 5 may be included in or otherwise combined with the components of FIG. 1 to create a variety of arrangements of components according to the subject matter described herein

Browser 404 and web application 504 each provide a user interface for navigating a hierarchy of nodes. A node in a hierarchy is and/or represents a tangible object and/or an object having a tangible representation. Thus, the term node and terms for objects and/or representations of objects that nodes are and/or represent are used interchangeably in this document. For example, in a hierarchical file system a node in the file system is referred to as a node, a folder, a directory, a file, a document, and/or an image depending on the particular node.

Nodes in a hierarchy may be ordered according to their location in the hierarchy and/or based on their relationship(s) with other node(s). A secondary order may be configured for child nodes of a parent node based on any attribute associated with the child node, including node name; time of creation, modification, and/or access; content type; and/or owner to name a few examples.

Examples of navigable hierarchies of nodes include file systems; lightweight directory access protocol (LDAP) directories; operating system registries; document tables of contents; taxonomies such as a biological taxonomies; genealogies; extensible markup language (XML) documents; hierarchical menus and toolbars; and hierarchical name spaces such as geospatial name spaces, political name spaces, the Internet domain name space (DNS) and/or a uniform resource identifier (URI) name space such as the HTTP scheme name space and the resources identified by each name in each name space. Those skilled in the art will recognize that various applications exist that allow user navigation of these hierarchies and other hierarchies not listed.

A visual representation of a node or other entity is presented by a display device as a user interface element. A user interface element is an element or visual component of a GUI. Exemplary user interface elements include windows, dialog boxes, textboxes, various types of button controls including check boxes and radio buttons, sliders, list boxes, drop-down lists, spinners, various types of menus, toolbars, ribbons, combo boxes, tree views, grid views, navigation tabs, scrollbars, labels, tooltips, text in various fonts, balloons, and dialog boxes. Those skilled in the art will know that this list is not exhaustive. The terms visual representation, visual component, and user interface element are used interchangeably in this document.

A user interface element handler component is a component configured to send information representing a program entity for presenting a visual representation of the program entity by a display. The visual representation is presented based on the sent information. The sent information is referred to herein as representation information. Representation information includes data in one or more formats including image data formats such as JPEG; video formats and multimedia container formats such as MPEG-4; markup language data such as HTML and other XML-based markup; and/or instructions such as those defined by various script languages, byte code, and/or machine code.

For example, a web page received by a browser from a remote application provider may include HTML. ECMAScript, and/or byte code for presenting one or more user interface elements included in a user interface of the remote application.

A program entity is an object included in and/or otherwise processed by an application or other program component, such as a node in a hierarchy. A representation of a program entity may be represented and/or otherwise maintained in a presentation space.

A presentation space is a location in a memory for storing a representation of a user interface element for presentation by a display. Memory suitable for supporting a presentation space includes processor memory 118, secondary storage 108, a buffer provided by display adapter 112, and a screen of display device. A presentation space accessible by a device may be accessible via a remote device.

A node in a hierarchy identified for determining a visually navigable path in a hierarchy of nodes is referred to herein as a start node with respect to the path. A visual representation of a start node is referred to as a start visual representation, start visual component, and/or a start user interface element. A path includes multiple nodes in the hierarchy.

A start visual representation may be presented on display 130 to in a manner that represents and/or otherwise identifies a start node as the current location in the hierarchy of nodes. In this context, the start node is referred to as the current location node. While navigating a path determined from the start node, each node in the path becomes the current location node as it is visually presented in path traveral.

When a node in the path becomes the current location node during navigating, a visual representation of the node is presented where the visual representation has a visual attribute that identifies the node as the current location node.

For example, a visual representation of the current location node may be a represented with a different color than visual representations of other nodes presented on the display along with it. Any visual attribute or combination of visual attributes may be used to identify the current location node.

Alternatively or additionally, a navigating application may traverse a path by presenting only the current location node in a user interface element on the display; thus when a node in the path is represented in the user interface element it indicates the represented node is the current location node.

An execution environment, such as execution environment 102 and those described below may include one or more node user interface element handler components. A node user interface element handler component may be and/or may make use of a user interface element handler component. Thus descriptions related to user interface element handlers apply to node user interface element handler components.

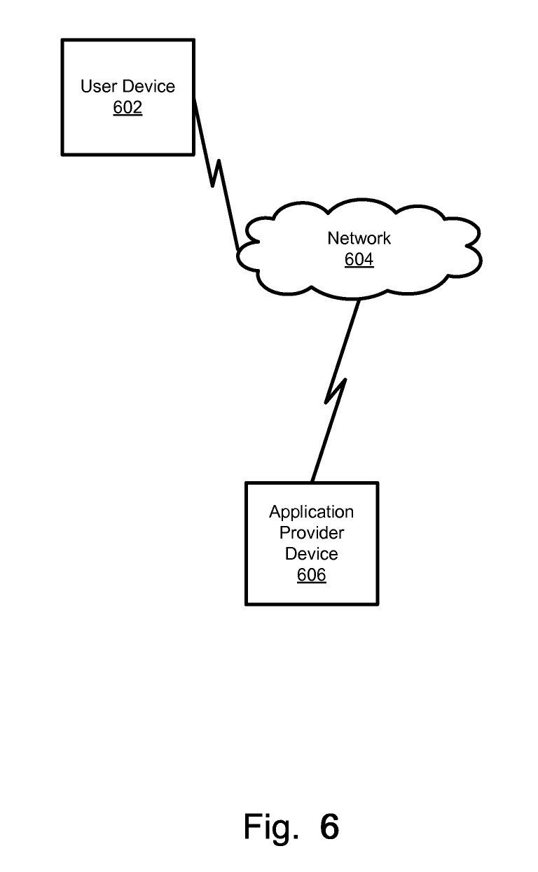

FIG. 4 depicts adaptations and/or analogs of the arrangement of components in FIG. 3 in browser 404 along with a number of other user interface element handler components 406. Execution environment 402 includes a device illustrated in FIG. 6 as user device 602. 6. User device 602 is illustrated operatively coupled to network 604 via a communications interface, such as NIC 114. Browser 404 operating in user device 602 may access resources provided by one or more network devices operatively coupled to network 604 such as application provider device 606 as FIG. 6 illustrates.

The adaptations and/or analogs of the arrangement of components in FIG. 3 illustrated in FIG. 4 may operate as part of a remote application client 408 operating in and/or otherwise processed by components of browser 404 and/or extensions of browser 404. A hypertext markup language (HTML) based web page including script code and/or byte code when operating in and/or otherwise processed by a browser is an example of a remote client application provided by a remote application operating in a remote node. Remote application client 408 in FIG. 4 operating in user device 602 may be a portion of web application 504 in FIG. 5. Web application 504 may operate in application provider device 606. Remote application client 408 may be received by user device 602 from application provider device 606 via network 604.

While the descriptions in this document focus on operation of adaptations and analogs of the arrangement of components in FIG. 3 included in a remote application client operating in a browser and/or included in a provider of the remote application client, those skilled in the art will recognize that adaptations and/or analogs of the arrangement of components in FIG. 3 may be adapted to operate in stand-alone applications such as file system explorers, applications including hierarchical menus, and XML document editors.

Those skilled in the art will further recognize upon reading this document that adaptations and/or analogs of the arrangement of components in FIG. 3 may be distributed across devices in a distributed execution environment. For example browser 404 in user device 602 and web application 504 in application provider device 606 provide a distributed execution environment for various adaptations of the arrangement of components in FIG. 3.

The method illustrated in FIG. 2 may thus be performed wholly in a single device, such as user device 602 and/or application provider device 606, or may be performed by an arrangement of components operating partially in multiple devices included in a distributed execution environment.

FIG. 4 illustrates presentation controller component 410 and script execution environment component 412 as components of browser 404. Presentation controller component 410 along with script execution environment component 412 manages a user interface of browser 404. The user interface of browser 404 includes visual components presented on display 130 of user device 602. The visual components or visual representations are presented through the operation of corresponding user interface element handler components 406.

While FIG. 4 illustrates user interface element handler components 406 operating outside script execution environment component 412, at least some user interface element handler components and/or portions thereof may operate in script execution environment component 412. Node user interface element handler component 456 illustrates this aspect.

Since a node user interface element handler component may be a user interface element handler component, a node user interface element handler component in various aspects may be at least partially included in script execution environment component 412 and/or may be external to script execution environment component 412. A node user interface element handler component operating external to script execution environment component 412 may be operatively coupled to script execution environment component 412 or not, depending on an including arrangement of components for performing the method illustrated in FIG. 2. A node user interface element handler component may operate in one or more of script execution environment component 412, presentation controller component 410, another component of browser 404, and/or a plug-in or other extension of browser 404.

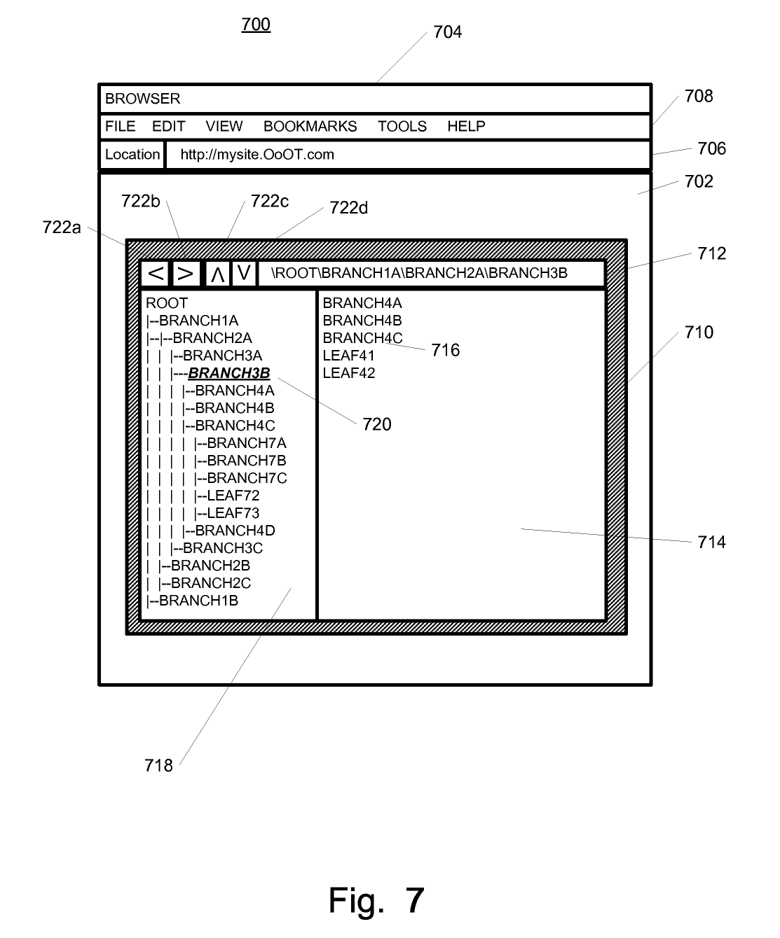

FIG. 7 illustrates an exemplary user interface 700 of browser 404 in FIG. 4. User interface elements of browser 404 illustrated in user interface 700 include page/tab pane 702 user interface element. Page/tab pane 702 includes a presentation space for presenting a user interface of an application, such as remote application client 408 and/or web application 504 in FIG. 5.

Other exemplary visual components of the user interface of browser 404 illustrated FIG. 7 title bar 704 user interface element, location bar 706 user interface element, and menu bar 708 user interface element including user interface elements representing menu items. Task pane 710 user interface element illustrates an exemplary user interface of web application 504 in FIG. 4 presented via remote application client 408 in FIG. 4. Other user interface elements typically included in browser user interfaces are not shown for ease of illustration.

Node user interface element handler component 456 displays on and/or otherwise by display 130 a visual representation of a node in a hierarchy by sending representation information representing the node to windowing manager component 414 for presenting a visual representation of the node based on the representation information.

A current location in a path may be indicated by presenting a single visual representation of a node in a path without presenting visual representations of the nodes in the path at the same time on the display 130. For example, current location node text box 712 in FIG. 7 includes a visual representation of a current location node in a hierarchy presented as a text identifier, “Root\Branch1A\Branch2A\Branch3B”, in a content region of current location text box 712. The visual representation is based on representation information representing the node sent by a node user interface element handler component 456.

In FIG. 7, content pane 714 also illustrates a visual representation of the current location node. Remote application client 408 operating in and/or otherwise processed by browser 404 visually indicates the current location in the hierarchy by presenting, in content pane 714, visual representations of one or more child nodes of the current location node. A child node visually represented by label 716, “Branch4C”, identifies the current location node via its relationship to its parent node. The label 716 visually representing the child node with respect to the current location node is presented based on representation information representing the child node as a child node of the current location node. The representation information for presenting the child node is sent by a corresponding node user interface element handler component 456 representing the child node and thus indirectly representing and identifying the current location node. Thus, label 716 in FIG. 7 illustrates a visual representation indicating a current location in the hierarchy. The visual representation is presented on display 130 by a node user interface element handler 456.

A current location in a path may be visually indicated by presenting a visual representation of a node in the path having a visually distinguishable attribute from other presented visual representations of nodes. The visually distinguishable attribute may indicate the visual representation represents the current location in the hierarchy and/or in the path during path traveral described below.

For example, tree view pane 718 user interface element, in FIG. 7, includes visual representations of nodes included in the hierarchy. Tree branch 720 user interface element, “Branch3B”, identifies the current location node in the context of the portion of the hierarchy presented in tree view pane 718. Tree branch 720 is presented with a visual attribute distinguishing it visually from other tree branch and tree leaf user interface elements in tree view pane 718. The visually distinguishing attribute identifies the current location in navigating the hierarchy and, thus, indicates the node as the current location node.

As just described, current location text box 712, content pane 714, and tree view pane 718, in FIG. 7, illustrate that one or more node user interface element handler components 456 in FIG. 4 may be configured to send representation information representing the current location node and that the current location node may have multiple visual representations that differ. The visual representations of the current location node in FIG. 7 may also illustrate a start node; the statements in this paragraph are true for start nodes and their corresponding start visual representations.

In FIG. 4, windowing manager component 414 may include components having one or more application programming interfaces (APIs) that may be invoked by node user interface element handler component 456 and/or other user interface element handler components 406 to present user interface elements of various types in a presentation space provided by display 130. Node user interface element handler component 456 and/or other user interface element handler components 406 interoperate with an API of windowing manager component 414 directly and/or indirectly via another component, such as presentation controller component 410 and/or script execution environment component 412.

In FIG. 4, windowing manager component 414 is operatively coupled to graphics subsystem component 416. Graphics subsystem component 416 may include one or more subcomponents callable via corresponding APIs for drawing text and/or geometric shapes into a memory buffer for presentation on display 130. Based on the representation information sent by node user interface element handler component 456, windowing manager component 414 instructs graphics subsystem component 416 to draw a representation of the respective node in a display buffer. Other user interface element handler components 406 may interoperate with windowing manager component 414 to send information representing corresponding user interface elements for presentation on display 130 analogously.

Graphics subsystem component 416 as illustrated in FIG. 4 may communicate with display 130 via display adapter component 112 as described above with respect to FIG. 1 to present a visual representation of a node based on the representation information sent from node user interface element handler component 456. Other user interface elements may be processed analogously for presentation on display 130 based on representation information representing corresponding user interface elements sent from various user interface element handler components 406.

Remote application client 408 in FIG. 4 may be received by content manager component 418 via network stack component 420 and optionally via an application layer component interoperating with network stack component 420. Remote application client 408 may be received as information sent by web application 504. Hypertext transfer protocol (HTTP) layer component 422 and a publish-subscribe protocol layer component shown as XMPP-IM layer component 424 illustrate exemplary application protocol layer components.

In FIG. 4, content manager component 418 routes at least some information received from web application 504 in FIG. 5 to one or more content handler components 426. Routing is based on a content type of at least some of the received information. The received information may include data having one or more content types, thus portions of received information may be distributed to one or more content handler components 426.

Examples of content handler components include text/html content handler component 426a for processing HTML documents; application/xmpp-xml content handler component 426b for processing XMPP streams including presence tuples, instant messages, publish-subscribe data, and request-reply style messages as defined by various XMPP specifications; video/mpeg content handler component 426c for processing MPEG streams; and image/jpeg content handler component 426d for processing JPEG images. Content handler components 426 process received information and may provide a representation of the processed information to one or more user interface element handler components 406 such as node user interface element handler component 456. A content handler component 426 and/or script execution environment component 412 may create a node user interface element handler component and/or otherwise communicate with a node user interface element handler component included in browser 404 and/or an extension of browser 404 to present a visual representation of a node represented by received information from, for example, web application 504 in FIG. 5.

Alternatively or additionally, content manager component 418 communicates directly with one or more user interface element handler components 406 such as a node user interface element handler component in presentation controller component 410.

FIG. 5 illustrates node user interface element component 556 as an adaptation of and/or a analog of node user interface element handler component 356 in FIG. 3. One or more node user interface element component 556 operates in web application 504 along with a number of other user interface element handler components 506.

Web application 504 as illustrated is arranged according to a model-view-controller (MVC) design pattern. The MVC design pattern will be recognized by those skilled in the art as one of a number of alternative design patterns usable for arranging components of a network application. Web application 504 includes controller component 508 to coordinate communication with one or more client devices, such as user device 602. Controller component 508, routes information to and from various components included in view subsystem 510 and model subsystem 512 in FIG. 5.

As described above, user interface elements including and included in task pane 710 in FIG. 7 illustrate a user interface of web application 504. A user interface element representing a node in a hierarchy may be and/or may represent any object an application is configured to represent or otherwise process including a person, a group, a class, and/or a command.

View subsystem 510 components include template engine component 514 and one or more user interface element handler components 506. One or more user interface element handler components 506 operate as one or more node user interface element handler components 556, as FIG. 5 illustrates. User interface element handler components 506 including one or more node user interface element handler components 556 are operatively coupled to controller component 508 directly and/or indirectly according to various aspects.

In FIG. 5, node user interface element component 556 is configured present a visual representation of a node, such as the current location node on a display of a client device, such as user device 602. Node user interface element component 556 provides for presenting the visual representation by sending representation information representing, for example, the current location node to controller component 508. At least a portion of data representing a node in the hierarchy or other program entity having a visual representation may be stored as static data, such as HTML or data values. Template 522 illustrates a form of static data stored in a file system (not shown) or database, illustrated as template database 524.

Dynamic data and data for dynamically generating data in web application 504 is stored in model database 526. Model database 526 is accessed by view subsystem 510 via model subsystem 512 as directed by controller 508. Data representing a node may be generated and/or otherwise determined dynamically by web application 504.

In an example, in response to a request received from browser 404 in FIG. 4, controller 508 in FIG. 5 invokes model subsystem 512 to determine the current location node for presenting. Controller 508 invokes template engine 514 to identify template 522 for including representation information for some or all of task pane 710. Template 522 includes one or more placeholders for variable data determined dynamically for representing the current location node. Template engine 514 processes template 522 interpreting script code in template 522 configured to invoke node user interface element handler component 556 to fill in variable data representing the current location node. Node user interface element handler 556 interoperates with model subsystem 512 to receive data representing the current location node. Node user interface element handler 556 generates representation information representing the current location node and sends it to template engine 514. Template 522 as processed by template engine 514 is filled in based on the representation information. The processed template is provided to controller 508 by view subsystem 510 for sending to browser 404 in FIG. 4. The data including representation information representing the current location node is sent, as described below, to browser 404 for presenting the visual representation indicating the current location in the hierarchy based on the representation information. The example just describe reflects one a many possible configuration of the components of web application 504.

Continuing with the example, controller component 508 in FIG. 5 operating in application provider device 606 in FIG. 6 transmits the representation information in one or more messages over network 604 to user device 602. Controller component provides message content to web server component 516. Web server component 516 constructs one or more application layer component and/or network layer component messages and provides them to web protocol layer component 518 and/or network stack component 520 to package and provide to the network interface component of application provider device 606. The network interface component, such as an Ethernet adapter, provides packets including message data from controller component 508 to network 604 for transmitting to user device 602.

As described in the example, the representation information is sent in response to a request from browser 404 in FIG. 4. Controller component 508 in FIG. 5 receives the request in one or more messages from browser 404 sent by user device 602 in FIG. 6, transmitted over network 604. Execution environment 502 in application provider device 606 may receive one or more packets of data sent from user device 602. The data in the packets is processed by network stack component 520 which constructs messages suitable for processing by web server component 516 and/or suitable for processing by one or more application protocol layer components illustrated in FIG. 5 as web protocol layer component 518. Exemplary application protocols include HTTP, FTP, and SIP.

In an alternative, web application 504 in FIG. 5 invokes node user interface element handler component 556 to send representation information asynchronously to browser 404 in FIG. 4 one or more messages without receiving a corresponding request. An asynchronous message may be sent in response to a change detected by web application 504 other than request sent by browser 404.

With reference to FIG. 2, block 202 illustrates the method includes detecting a first navigation input from a user. Accordingly, a system for traversing nodes in path on a display device includes means for detecting a first navigation input from a user. For example, as illustrated in FIG. 3, a navigation controller component 352 is configured for detecting a first navigation input from a user.

In various alternatives, navigation controller component 352 may detect a user input as a navigation input via an operative coupling with any number of components included in an execution environment. In FIG. 3, navigation controller component 352 may receive navigation information and/or otherwise detect a navigation input from a user via the illustrated operative coupling to user interface element handler component 356. The coupling may be direct or indirect via one or more other components.

A navigation input is detected by navigation controller component 352 based on a user input detected by input device 128 in FIG. 1. For example, a visual representation of a node and a presented pointer are displayed at least partially in a shared region of a presentation space of display 130. An input, for example a mouse click, is detected by input device 128 while the user interface element representing the node and the pointer share the region. The mouse click may identify the node as a start node. The mouse click may also be detected as a navigation input.

Alternatively or additionally, the start node is represented by a visually distinguished start visual representation as described above when the input is detected. For example, the current location node may be identified as the start node. The visual distinction, in the example, defines a correspondence between the detected input and the start visual representation.

FIG. 4 illustrates navigation controller component 452 as an adaptation of and/or analog of navigation controller 352 in FIG. 3. In FIG. 4, navigation controller component 452 operates in browser 404.

Navigation controller component 452 in FIG. 4, as well as other adaptations of the components in FIG. 3 adapted for operation in browser 404, operates in script execution environment component 412. Alternatively or additionally, some or all of a navigation controller component may operate external to script execution environment component 412. At least part of a navigation controller component may be included in an extension of browser 404, operate in a virtual machine supported by browser 404 such as a Java Virtual Machine (JVM), and/or operate as component of browser 404 outside script execution environment component 412. At least part of a navigation controller component may be received from a remote device. For example, web application 504 may send via network 604 remote application client 408 as a web page including a script version of navigation controller component 452 for operating in script executing environment component 412 as FIG. 4 illustrates. Analogous statements apply to all components in FIG. 3 adapted for performing the method illustrated in FIG. 2 in various execution environments.

A navigation input is detected by navigation controller component 452 in response to an input detected by an input device. The navigation input is defined by navigation controller component 452 and/or other components to indicate a path traversal process is to be performed. The path is determined based on an identified start node and includes a plurality of nodes in the hierarchy. The start node may be the current location node in an aspect.

In an example, a pointer device detects input from a user while a pointer is presented in a location on the display shared by a navigation button 722. In response, a navigation input is generated in processing the detected input by one or more components including input device 128, input driver component 428, presentation controller component 410, a node user interface element handler component corresponding to the current location node, and a user interface element handler component such as a user interface element handler component corresponding to the particular navigation button, such as up navigation button 722c.

The navigation input may or may not identify a direction of navigation. For example, a navigation input for the input detected corresponding to a navigation button 722 also identifies a direction such as left, right, up, or down direction when the corresponding user interface element is left navigation button 722a, right navigation button 722b, up navigation button 722c, or down navigation button 722d, respectively.

A start node may be identified by navigation controller component 452 based on the detected input's configured correspondence with the identifier visually represented in current location text box 712 when the input is detected. Alternatively or additionally, a child node identifier such as label 716 visually represented in content pane 714 when the input is detected may identify its parent node as the start node. In an aspect, a visually distinguished node (not shown) in content pane 714 when the input is detected may identify the start node. Alternatively or additionally, a visually distinguished label, such as label 720, presented in tree view pane 718 may identify the start node when visually distinguished during detection of the input. Alternatively, the start node may be determined based on another attribute other than current location.

Alternatively or additionally, input detected by input devices other than a mouse may be or otherwise result in generation of a navigation input as those skilled in the art will see. Exemplary input devices are named above in the description of FIG. 1.

A detected navigation input may be a particular pattern of inputs, such a pattern of key inputs detected by a keyboard adapter or button adapter included in a handheld device. The pattern may correspond to one or more soft input controls in addition to a hardware input device.

FIG. 5 illustrates navigation controller component 552 as an adaption of and/or analog of navigation controller component 352 in FIG. 3. FIG. 5 illustrates navigation controller component is configured to operate in web application 504. Navigation controller component 552 in FIG. 5 is included in model subsystem 512 providing at least some of the business logic of web application component 504.

Navigation controller component 552, as illustrated in FIG. 5, is configured to receive a navigation input via an input device. The input device may be an input device operatively coupled to user device 602. The navigation input may be detected in correspondence with presentation of the user interface, task pane 710, of web application component 504.

In response to the detected navigation input, user device 602 may send a message including navigation input information based on the detected navigation input to web application 504 in application provider device 606 via network 604. For example, in FIG. 4, content manager component 418 may send messages as directed by one or more content handler components 426, and/or the presentation controller component 410 and/or its components. A message may be sent in response to a navigation input detected by an input device in correspondence with presentation of a visual representation of the current location node by the display of user device 602. The message may include a navigation input and/or may include input information for detecting the navigation input by navigation controller component 552 in FIG. 5.

Controller component 508 may route the navigation input and/or information based on the detected navigation input to model subsystem 512. Model subsystem 512 may route the navigation input to navigation controller component 552. Alternatively, controller component 508 may route the navigation input to node user interface element handler component 556 operatively coupled to navigation controller component 552 directly and/or indirectly via model subsystem 512 to provide the navigation input and/or information based on the detected navigation input to navigation controller component 552.

The above description illustrates that detecting a navigation input may include receiving message sent via a network, by a remote device, in response to a user input detected by the remote device.

For example, a message may be received sent by user device 602 in response to a user input detected by user device 602. User device 602 may send the message via a network. The message may be received by a receiving device such as application provider device 602 hosting navigation controller component 552.

Alternatively, or additionally, detecting a navigation input may include receiving a message by a user device received from a remote device such as application provider device 606. Application provider device 606 may detect a navigation input as described above and send a message to user device 602 hosting navigation controller component 452 configured to detect the navigation input based on the message received from application provider device 602 via network 604.

Further the above description illustrates that a current location in hierarchy and/or a direction for determining a path to traverse may be identified based on detecting a navigation input.

Returning to FIG. 2, block 204 illustrates the method further includes determining a first path including a first plurality of nodes in a hierarchy. Accordingly, a system for traversing nodes in path on a display device includes means for determining a first path including a first plurality of nodes in a hierarchy. For example, as illustrated in FIG. 3, a path selector component 354 is configured for determining a first path including a first plurality of nodes in a hierarchy

Path selector component 354 as illustrated in FIG. 3 is operatively couple to navigation controller component 352. The coupling may be direct or indirect via one or more other components included in a hosting execution environment. Navigation model component 358, an optional component of the arrangement, is illustrated as operatively coupled to navigation controller component 352 and/or path selector component 354 in FIG. 3. In various alternative arrangements of the components, navigation model component 358 may be directly or indirectly coupled to any one or more of the other components illustrated in FIG. 3

The detected navigation input may identify a direction of navigation for determining one or more of the plurality of nodes in the path. For example, the input detected may correspond to a hardware navigation button and/or a navigation button user interface element presented on display 130. Identifiable navigation directions include left, right, up, and down.

Alternatively or additionally, a input is detected that results in a navigation input that does not identify a particular direction or results in generation of a navigation input that identifies more than one direction as described in more detail below. A direction of navigation may be based on one or attributes of the identified start node and/or any node included in the path, and/or a node in the hierarchy related to a node in the path.

In an aspect, path selector component 354 receives path input information identifying a path pattern and/or a path policy for generating a path pattern. The path pattern may identify at least one of the start node and a direction. Alternatively, a path pattern may be completed based on a received start node identifier and/or direction identifier. Similarly, a path policy may be evaluated by identifying the start node and/or one or more directions as input. A path pattern may identify a pattern of travel or movement irrespective of the location in the hierarchy of the current location node. A path pattern may identify one or more directions of travel or movement in navigating a hierarchy.

The start node may be the current location node. The identified direction and/or the start node for determining the path may be determined based on the detected navigation input, such as a navigation button 722, and/or may be determined based on a navigation policy maintained by navigation model component 358 when present. For example, if the direction is “right”, path selector component 354 may identify a sibling node of the start node as a first path node in the path. Note a start node is used for determining a path and may or may not be included in the path. A path node is a node included in the determined path.

A path pattern, for example, may identify a one or more directions, such as up, and a number of nodes, such as three indicating the traversing process to be performed is directed to navigate three nodes up the hierarchy from the start node. In addition to or instead of identifying a number of nodes, a path pattern may identify one or more node attributes for determining a path including a particular node. A particular node may be identified by its location, such as the root node; a type of node, such as a node representing image data; and/or a relation of a node to another node in the hierarchy. Navigation directions may be associated with the start node and/or other path nodes based on a node attribute.

Direction information may be determined based on one or more navigation policies maintained by an navigation model component 358 when present in an arrangement of components and/or when configured for use, in addition to and/or instead of based on information identified based on the detected navigation input and/or path input information. The direction information may be included in a path pattern determined by evaluating a navigation policy. A navigation policy may be included in navigation model component 358 by a developer and/or received as configuration data provided by a user or administrator of a hosting execution environment.

In an aspect, a direction of navigation may be determined based on an operation in progress during detecting of a navigation input, an operation completed prior to detecting a navigation input, and/or identified by the received navigation input or otherwise performed in response to the detected input resulting in the navigation input. Path selector component 354 may determine a single node and/or at least a portion of the nodes in the path including multiple nodes. That is, a path selector component 354, in an aspect, may determine a compete path prior to path traveral. In another aspect, a path selector component 354 may determine a first path node in a multi-node path. Subsequently the arrangement of components may again invoke path selector component 354 to determine a second path node after and/or during presenting a first path visual representation of the first path node by the display. The first path node is the preceding node of the second path node having a second path visual representation to replace the first path visual representation on the display. This process may repeat until the complete path traveral is visually represented on the display. In various aspects, a path selector component may determine any number of nodes in a path prior for presentation of visual representations of the determined nodes.

Path selector component 354 may interoperate with node user interface element handler components 356 via path controller component 352 and/or directly to identify each node in a path for presenting a visual representation of each node to replace a visual representation of a preceding node of each node in the path.

In an example based on FIG. 4 and FIG. 7, path selector component 454 in FIG. 4 may receive, based on the navigation input, navigation input information from path controller component 452 identifying an up direction and the start node identified by the string, ““\Root\Branch1A\Branch2A\Branch3B” in FIG. 7. Path selector component 454 may determine a first path node in the path to navigate and identify it for presentation prior to and/or during determination of a second path node in the path.

The path selector component 454 may request a navigation policy from navigation model component 458. The navigation policy may be identified based on the received navigation input information. When the start node is the current location node, navigation model component 458 may identify a navigation policy based on determining that the start node's level in the hierarchy is level 3. Path selector component 454 may evaluate the navigation policy to determine a path pattern identifying the first path node in the path. The navigation policy may return an identifier of the current location node's parent node.

The first path node as illustrated in FIG. 7 has identifier, “\Root\Branch1A\Branch2A\Branch3B”. The path selector component 454 identifies the first path node directly and/or indirectly to one or more node user interface element handler components for current location text box 712 to replace the start node's identifier with the identifier of the first path node; for content pane 714 to replace representations of child nodes of the start node with representations of child nodes of the first path node; and for tree view pane 718 to replace label 722a and label 722b so that label 722b is presented as the visually distinguished label indicating the associated node is the current location node.

Path selector component 454, in the example, is subsequently automatically invoked a second time with path information identifying the up direction, based on the previous navigation policy evaluation, and identifying the first path node in the path as the current location node. The process repeats automatically as described identifying the second path node as the parent of the first path node and the user interface is updated to replace the first path visual representation(s) of the first path node with the second path visual representation(s) of the second path node.

An action may be determined and/or otherwise identified to perform after visual representations of nodes in a path have been sequentially presented in time on a display device. An action handler may be invoked to perform the identified action. Exemplary actions handlers may halt traversing of a path, change visibly detectable attribute of a path node, create a new node and optionally add it to the path, and/or remove a path node from the path.

A particular navigation policy may identify an action to be taken after and/or otherwise in correspondence with display of a visual representation of a particular node. For example, the action identified may indicate the resource navigation window is to be closed after the traversing process presents a visual representation of the root node. Based on an identified action a corresponding action handler may be identified and invoked directly or indirectly. Alternatively, a root node navigation policy may identify a new direction and activate a navigation policy or navigation policy family to navigate the hierarchy or a portion such as sub-tree of the current location node in a depth first fashion.

During traversing of a path, a action input may be detected from a user. An action may be identified based on the action input, an attribute of a path node, and/or configuration information provided by a user prior to detecting the action input. For example, an action or operation may be identified to perform on and/or in correspondence with presenting the visual representation of one or more of the path nodes navigated while moving through the path. Nodes associated with performance of the operation may be identified, for example, by type and/or location in the path. A node for performing an action on may and/or an action to be performed may be determined based on a navigation policy, identified in a path pattern, and/or indicated by input information received via an input device during traversing of the nodes in a determined path.

In another example, during traversing as each node in a determined path is presented, an input device may detect a user input identifying a command such as open, delete, and/or view a preview. A system may be configured to identify an action handler component (not shown) to perform the action and invoke the action handler directly or indirectly. The action may be invoked for the current path node presented when the input is detected and/or automatically invoked for nodes in the path subsequently presented as the current location node. An action may be determined or otherwise identified based on an action indicator received in response to the detected input, an attribute of a node such its type, and/or based on user provided configuration information for the application.

In an aspect, an automatic traversing of a path is altered based on a user input detected during the traversing processing. For example, a user selection of a child node displayed in content pane 714 is detected halting traversing based on a navigation policy or based on configuration of a particular arrangement of components in the system.

During path traveral, a second navigation input from a user may be detected. The second navigation input may correspond to and/or otherwise identify a node in the path having a visual representation during the traversing. Based on the identified node, a second path including a second plurality of nodes in the hierarchy may be determined. The second path may be traversed by providing for sequentially presenting in time second visual representations of the nodes in the second path, the second visual representations visually indicating a current location in traversing the second path.

In an example, a second navigation input is detected during an active traversing process. The second navigation input may be detected based on a user input detected by an input device during the active path traveral. In an aspect, the second navigation input may be detected while a visual representation of a node in the path is presented. The second navigation input may correspond to the visual representation of the second node. The second node may be visually represented as the current location node. The second navigation input may be defined to identify the corresponding node as a start node. In effect, the second navigation input initiates traversing a second path starting at the corresponding node. In effect the corresponding node is a second start node with respect to the start node described above.

In response to the second navigation input a process for traversing the second path is initiated. The second traversing process may be viewed as altering the active traversing process and/or may be viewed as a separate traversing process. The original traversing process maybe halted prior to initiating the second traversing process. Alternatively the original traversing process may be allowed to continue prior to initiating the second traversing process, during the second traversing process, and/or after the second traversing process completes.

Those skill in the art will recognize a user may navigate from any node in a hierarchy to any other node in the hierarchy by providing at most two navigation inputs each corresponding to a navigation direction. Clearly the amount of input, particularly repetitive input, is reduced over current systems.

Alternatively or additionally, a second navigation input may alter the speed of a traversing process. For example, when the second navigation input identifies the same direction being processed by the active traversing process to determine a next node in the path, the arrangement of components responds by performing the active traversing process faster. That is, the visual representations of each node in the path may be presented for a shorter duration of time. An opposite direction indication may slow the traversing process.

In yet another aspect, received navigation information identifies the particular input detected. Based on the particular input, path selector component 454 and optionally navigation model component 458 may identify a path pattern having multiple direction indicators identifying a commonly repeated navigation pattern that may or may not depend on an attribute of the start node, the hierarchy, the user, the application, and/or other data detectable by execution environment 402.

FIG. 5 illustrates path selector component 554 as an adaptation of and/or analog of path selector 354 in FIG. 3. FIG. 5 illustrates path selector component 554 is configured to operate in web application 504 in execution environment 402.

In an example, in response to a message from browser 404 as described above, path selector component 554 receives, based on the navigation input, navigation input information from path controller component 552 identifying a “right” direction and the start node. The start node may be identified by the string, ““\Root\Branch1A\Branch2A\Branch3B” as in FIG. 7. Path selector component 554 may determine a complete path including multiple nodes in the hierarchy or may determine a portion of the path where the portion includes one or more path nodes in the hierarchy.

The path selector component 554 may request a navigation policy from navigation model component 558. The navigation policy may be identified based on the navigation input information. Navigation model component 558 may identify a navigation policy based on the relationships of the start node to other nodes in the hierarchy. For example, navigation model component 558 determines a navigation policy based on detecting the direction identified is “right” and based on detecting that the start node has sibling nodes. Sibling nodes are nodes having the same parent node. 3. Navigation model component 558 may evaluate the navigation policy to determine the path or a first portion including multiple nodes. The navigation policy may identify a path pattern including an ordered list of identifiers of nodes in the path. Additionally, navigation model component 558 may return additional direction information in the path pattern if the path determined does not follow a single direction.

The current location node, illustrated in FIG. 7, by the identifier, “\Root\Branch1A\Branch2A\Branch3B” may be identified as the start node. The path selector component 554 may provide the path pattern to one or more node user interface element handler components 556 for current location text box 712 to send representation information for each node identified in the path pattern to present a visual representation of each node in place of the preceding visual representation of the preceding node based on the order of the nodes specified by the path pattern. When Path selector component 554, in the example, determines only a portion of the path, path selector component 554 is subsequently automatically invoked a second time to determine at least a next portion of the remainder of the path.

In an aspect, the “right” direction may identify a path that traverses sibling nodes of the start node in some specified order such as name or creation date. Path traveral may end with presentation of a visual representation of the last sibling in the path. Alternatively, based on a navigation policy, the path based on a navigation policy continues to loop through the siblings one or more times and/or navigates to a node at the same level having a different parent based on an order of parent nodes.

Those skilled in the art will realize that the paths and path patterns identified in this document are merely exemplary and not exhaustive.

Returning to FIG. 2, block 206 illustrates the method additionally includes, in response to the first navigation input, traversing the first path by providing for sequentially presenting in time, by a display device, first visual representations of the nodes in the first path, the first visual representations indicating corresponding current locations during the traversing. Accordingly, a system for traversing nodes in path on a display device includes means for, in response to the first navigation input, traversing the first path by providing for sequentially presenting in time, by a display device, first visual representations of the nodes in the first path, the first visual representations indicating corresponding current locations during the traversing. For example, as illustrated in FIG. 3, a node user interface element handler component 356 is configured for, in response to the first navigation input, traversing the first path by providing for sequentially presenting in time, by a display device, first visual representations of the nodes in the first path, the first visual representations indicating corresponding current locations during the traversing

Node user interface element handler component 356 may be configured to display on device 130 visual representations of each node in the path determined by path selector component 354. For example Node user interface element handler component 356 may send representation information to windowing manager 414 as described above to present visual representations of each node in the path determined by path selector component 354. Operation of node user interface element handler has been described above.

In an aspect, node user interface element handler component 356 is invoked to present a single node in the path. In another aspect, node user interface element handler component 356 is invoked to present a series of nodes in the path. Node user interface element handler component 356 may be invoked by navigation controller component 352 and/or path selector component 354 based on the configuration of a particular arrangement of components.

One or more node user interface element handler component invocations may be sufficient to traverse the nodes according to a particular configuration. When all or more than one node is identified in the received path pattern information provided in an invocation of the node user interface element handler component 356, the node user interface element handler component 356 may send representation information for each node identified in the path information according to the order of the nodes in the path to present a visual representation of each node in place of its preceding node in the path. The replacing visual representation identifies the current location node in navigating the hierarchy. Node user interface element handler component 356 may perform the described process in this paragraph without further input or invocation, in various aspects.

The operations described above are performed automatically in response to the detected navigation input. As described path selector component 354 may interoperate with navigation model component 358 to determine a single next node in a path and/or to determine multiple next nodes in the path in response to a single invocation. Node user interface element handler 356 may be invoked according to the path pattern information determined.

Alternatively or additionally, node user interface element handler component 356 may receive additional path pattern information identifying one or more nodes in the path via asynchronous communication. That is, node user interface element handler component 356 may received unsolicited path information, for example, via invocation by navigation controller component 352, path selector component 354, or other component. Asynchronous communication may be configured based on, for example, message queues, interrupts, semaphores, locks, and new thread instantiation.

Node user interface element handler component 356 included in FIG. 3 and adapted for operation in execution environment 402 as illustrated in FIG. 4 as node user interface element handler component 456 may be additionally configured to receive path pattern information from path selector component 454 identifying one or more nodes in the path determined as described above. The path pattern information may be identical in format or different from that of the navigation input according to the particular arrangement of components.

Upon invocation, node user interface element handler component 456 may send representation information representing a next node in the determined path just as it sends representation information for the start node. Browser 404 may send messages including requests for receiving representation information representing remaining nodes identified in the path pattern. Alternatively, node user interface element handler component 456 may receive multiple messages in order asynchronously. Each message contains representation information for a next node in the path for replacing a visual representation of the next node's preceding node on display 130.

Processing for one or more node user interface element handler components 456 corresponding to user interface elements representing nodes in the path in current location text box 712, content pane 714, and tree view pane 718 may operate analogously.

Node user interface element handler component 356 included in FIG. 3 and adapted for operation in execution environment 502 as illustrated in FIG. 5 as node user interface element handler component 556 may be additionally configured to receive information identifying a path pattern from path selector component 554 identifying one or more nodes in the path determined as described above. The path pattern may be identical in format or different from that of the navigation input according to the particular arrangement of components.

Node user interface element handler component 556 may send representation information representing the determined path or portion of the path in a single message to browser 404 in user device 602 via controller 508 as described above. Alternatively, node user interface element handler component 556 may send representation information representing only a portion of the path pattern, such as representation information representing the first path node. Web application 404 may receive messages including requests for receiving representation information representing remaining nodes identified in the path pattern. Alternatively, node user interface element handler component 556 may send multiple messages synchronously to browser 404 in user device 602. A message contains representation information for a next node in the path for replacing a visual representation of the next node's preceding node on display 130 of user device 602.

As described above, in an alternative, web application 504 in FIG. 5 invokes node user interface element handler component 556 to send representation information asynchronously to browser 404 in FIG. 4 one or more messages without receiving a corresponding request. An asynchronous message may be sent in response to a change detected by web application 504 other than request sent by browser 404.

Processing for one or more node user interface element handler components 556 corresponding to user interface elements representing nodes in the path in current location text box 712, content pane 714, and tree view pane 718 may operate analogously.

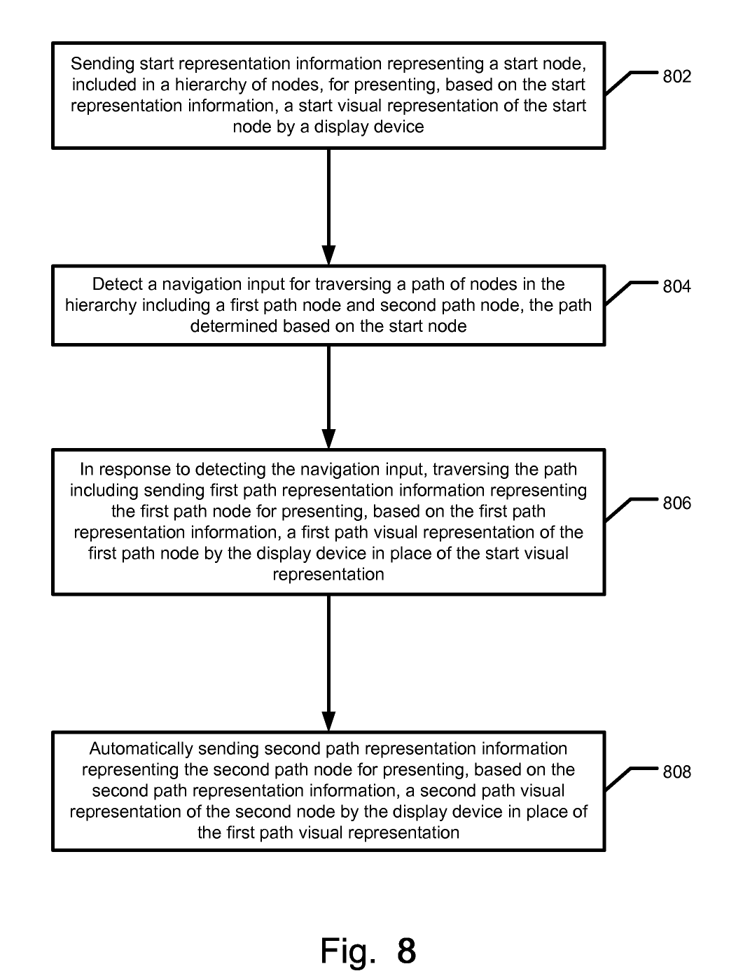

FIG. 8 is a flow diagram illustrating a method for traversing nodes in path on a display device according to an exemplary aspect of the subject matter described herein. FIG. 3 is a block diagram illustrating a system for traversing nodes in path on a display device according to another exemplary aspect of the subject matter described herein. FIG. 4 and FIG. 5 illustrate the components of FIG. 3 and/or their analogs adapted for operation execution environment 402 and execution environment 502, respectively, provided by one or more nodes. The method illustrated in FIG. 8 may be carried out by, for example, some or all of the exemplary arrangements of components illustrated in FIG. 3, FIG. 4, FIG. 5, and their analogs as described above.

With reference to FIG. 8, block 802 illustrates the method includes sending start representation information representing a start node, included in a hierarchy of nodes, for presenting, based on the start representation information, a start visual representation of the start node by a display device. Accordingly, a system for traversing nodes in path on a display device includes means for sending start representation information representing a start node, included in a hierarchy of nodes, for presenting, based on the start representation information, a start visual representation of the start node by a display device. For example, as illustrated in FIG. 3, a node user interface element handler 356 component is configured for sending start representation information representing a start node, included in a hierarchy of nodes, for presenting, based on the start representation information, a start visual representation of the start node by a display device.

Block 804 illustrates the method further includes detecting a navigation input for traversing a path of nodes in the hierarchy including a first path node and second path node, the path determined based on the start node. Accordingly, a system for traversing nodes in path on a display device includes means for detecting a navigation input for traversing a path of nodes in the hierarchy including a first path node and second path node, the path determined based on the start node. For example, as illustrated in FIG. 3, a navigation controller component 352 is configured for detecting a navigation input for traversing a path of nodes in the hierarchy including a first path node and second path node, the path determined based on the start node.

Block 806 illustrates the method still further includes in response to detecting the navigation input, traversing the path including sending first path representation information representing the first path node for presenting, based on the first path representation information, a first path visual representation of the first path node by the display device in place of the start visual representation. Accordingly, a system for traversing nodes in path on a display device includes means for in response to detecting the navigation input, traversing the path including sending first path representation information representing the first path node for presenting, based on the first path representation information, a first path visual representation of the first path node by the display device in place of the start visual representation. For example, as illustrated in FIG. 3, a path selector component 354 is configured for in response to detecting the navigation input, traversing the path including sending first path representation information representing the first path node for presenting, based on the first path representation information, a first path visual representation of the first path node by the display device in place of the start visual representation.

Block 808 illustrates the method additionally includes automatically sending second path representation information representing the second path node for presenting, based on the second path representation information, a second path visual representation of the second path node by the display device in place of the first path visual representation. Accordingly, a system for traversing nodes in path on a display device includes means for automatically sending second path representation information representing the second path node for presenting, based on the second path representation information, a second path visual representation of the second path node by the display device in place of the first path visual representation. For example, as illustrated in FIG. 3, a path selector component 354 is configured for automatically sending second path representation information representing the second path node for presenting, based on the second path representation information, a second path visual representation of the second path node by the display device in place of the first path visual representation.

It is noted that the methods described herein, in an aspect, are embodied in executable instructions stored in a computer readable medium for use by or in connection with an instruction execution machine, apparatus, or device, such as a computer-based or processor-containing machine, apparatus, or device. It will be appreciated by those skilled in the art that for some embodiments, other types of computer readable media are included which may store data that is accessible by a computer, such as magnetic cassettes, flash memory cards, digital video disks, Bernoulli cartridges, random access memory (RAM), read-only memory (ROM), and the like.

As used here, a “computer-readable medium” includes one or more of any suitable media for storing the executable instructions of a computer program such that the instruction execution machine, system, apparatus, or device may read (or fetch) the instructions from the computer readable medium and execute the instructions for carrying out the described methods. Suitable storage formats include in one or more of an electronic, magnetic, optical, and electromagnetic format. A non-exhaustive list of conventional exemplary computer readable medium includes: a portable computer diskette; a RAM; a ROM; an erasable programmable read only memory (EPROM or flash memory); optical storage devices, including a portable compact disc (CD), a portable digital video disc (DVD), a high definition DVD (HD-DVD™), a BLU-RAY disc; and the like.

It should be understood that the arrangement of components illustrated in the Figures described are exemplary and that other arrangements are possible. It should also be understood that the various system components (and means) defined by the claims, described below, and illustrated in the various block diagrams represent logical components in some systems configured according to the subject matter disclosed herein.

For example, one or more of these system components (and means) may be realized, in whole or in part, by at least some of the components illustrated in the arrangements illustrated in the described Figures. In addition, while at least one of these components are implemented at least partially as an electronic hardware component, and therefore constitutes a machine, the other components may be implemented in software that when included in an execution environment constitutes a machine, hardware, or a combination of software and hardware.

More particularly, at least one component defined by the claims is implemented at least partially as an electronic hardware component, such as an instruction execution machine (e.g., a processor-based or processor-containing machine) and/or as specialized circuits or circuitry (e.g., discreet logic gates interconnected to perform a specialized function). Other components may be implemented in software, hardware, or a combination of software and hardware. Moreover, some or all of these other components may be combined, some may be omitted altogether, and additional components may be added while still achieving the functionality described herein. Thus, the subject matter described herein may be embodied in many different variations, and all such variations are contemplated to be within the scope of what is claimed.

In the description above, the subject matter is described with reference to acts and symbolic representations of operations that are performed by one or more devices, unless indicated otherwise. As such, it will be understood that such acts and operations, which are at times referred to as being computer-executed, include the manipulation by the processor of data in a structured form. This manipulation transforms the data or maintains it at locations in the memory system of the computer, which reconfigures or otherwise alters the operation of the device in a manner well understood by those skilled in the art. The data is maintained at physical locations of the memory as data structures that have particular properties defined by the format of the data. However, while the subject matter is being described in the foregoing context, it is not meant to be limiting as those of skill in the art will appreciate that various of the acts and operation described hereinafter may also be implemented in hardware.

To facilitate an understanding of the subject matter described below, many aspects are described in terms of sequences of actions. At least one of these aspects defined by the claims is performed by an electronic hardware component. For example, it will be recognized that the various actions may be performed by specialized circuits or circuitry, by program instructions being executed by one or more processors, or by a combination of both. The description herein of any sequence of actions is not intended to imply that the specific order described for performing that sequence must be followed. All methods described herein may be performed in any suitable order unless otherwise indicated herein or otherwise clearly contradicted by context

The use of the terms “a” and “an” and “the” and similar referents in the context of describing the subject matter (particularly in the context of the following claims) are to be construed to cover both the singular and the plural, unless otherwise indicated herein or clearly contradicted by context. Recitation of ranges of values herein are merely intended to serve as a shorthand method of referring individually to each separate value falling within the range, unless otherwise indicated herein, and each separate value is incorporated into the specification as if it were individually recited herein. Furthermore, the foregoing description is for the purpose of illustration only, and not for the purpose of limitation, as the scope of protection sought is defined by the claims as set forth hereinafter together with any equivalents thereof entitled to. The use of any and all examples, or exemplary language (e.g., “such as”) provided herein, is intended merely to better illustrate the subject matter and does not pose a limitation on the scope of the subject matter unless otherwise claimed. The use of the term “based on” and other like phrases indicating a condition for bringing about a result, both in the claims and in the written description, is not intended to foreclose any other conditions that bring about that result. No language in the specification should be construed as indicating any non-claimed element as essential to the practice of the invention as claimed.

The embodiments described herein included the best mode known to the inventor for carrying out the claimed subject matter. Of course, variations of those preferred embodiments will become apparent to those of ordinary skill in the art upon reading the foregoing description. The inventor expects skilled artisans to employ such variations as appropriate, and the inventor intends for the claimed subject matter to be practiced otherwise than as specifically described herein. Accordingly, this claimed subject matter includes all modifications and equivalents of the subject matter recited in the claims appended hereto as permitted by applicable law. Moreover, any combination of the above-described elements in all possible variations thereof is encompassed unless otherwise indicated herein or otherwise clearly contradicted by context.

I claim:

1. A method for traversing nodes in path on a display device, the method comprising:
detecting a first navigation input from a user;
determining a first path including a first plurality of nodes in a hierarchy; and
in response to the first navigation input, traversing the first path by providing for sequentially presenting in time, by a display device, first visual representations of the nodes in the first path, the first visual representations indicating corresponding current locations during the traversing.

2. The method of claim 1 wherein detecting the first navigation input includes receiving a message sent via a network, by a remote device, in response to a user input detected by the remote device.

3. The method of claim 1 further comprising:
identifying a current location in the hierarchy as a start node;
identifying a navigation direction with respect to the current location; and
determining a node in the plurality based on the navigation direction and the start node.

4. The method of claim 3 wherein at least one of the current location and the navigation direction is the identified based on the first navigation input.

5. The method of claim 3 wherein the navigation direction is determined based on a operation in progress while detecting the first navigation input.

6. The method of claim 1 wherein determining the first path includes determining a node is included in the path based on based on an attribute the node.

7. The method of claim 6 wherein the attribute includes at least one associated with the node, a relation between the node to another node in the hierarchy, and a location of the node in the hierarchy.

8. The method of claim 1 wherein determining the first path comprises:
identifying a start node for determining the first path;
identifying a path pattern identifying a first navigation direction; and
determining the plurality of nodes based on the start node and the identified first navigation direction.

9. The method of claim 1 wherein a current location in the current locations indicated during the traversing is indicated by presenting a visual representation, in the first visual representations, in a user interface element including no other visible representations of other nodes in the hierarchy.

10. The method of claim 1 wherein a current location in the current locations indicated during the traversing is visually indicated by presenting a visual representation, in the first visual representations, having a visually distinguishable attribute indicating the visual representation represents the current location in the path.

11. The method of claim 1 further comprising:
determining an action to be performed after sequentially presenting the first visual representations; and
invoking an action handler identified by the determined action.

12. The method of claim 1 further comprising:
identify an action to perform associated with a node in the path; and
providing for invoking, during the traversing, an action handler for the identified action in association with presenting a visual representation, in the visual representations, of the node.

13. The method of claim 12 further comprises:
detecting an action input from a user; and
identifying the action based on at least one of the action input, an attribute of the node, and configuration information provided by a user prior to detecting the action input.

14. The method of claim 12 wherein the action handler at least one of halts the traversing, changes a visibly detectable attribute of the node, creates a new node and adds it to the path, and removes a node from the path.

15. The method of claim 1 further comprising:
detecting a second navigation input from a user while traversing the first path, the second navigation input identifying a node represented by a visual representation in the first visual representations;
determining, based on the identified node, a second path including a second plurality of nodes in the hierarchy; and
in response to the second navigation input; traversing the second path by providing for sequentially presenting second visual representations of the nodes in the second path, the second visual representations visually indicating corresponding current locations during traversing the second path.

16. The method of claim 1 wherein in providing for presenting a visual representation in the first visual representations sequentially presented includes displaying the visual representation on a display device.

17. The method of claim 1 wherein providing for presenting a visual representation in the first visual representations sequentially presented includes sending representation information representing a node in the path for presenting the visual representation based on the representation information by the display device.

18. The method of claim 17 wherein sending the representation information includes sending the representation in a message via a network to a user device having the display device.

19. The method of claim 18 where the message is sent asynchronously without receiving a corresponding request.

20. A method for traversing nodes in path on a display device, the method comprising:
sending start representation information representing a start node, included in a hierarchy of nodes, for presenting, based on the start representation information, a start visual representation of the start node by a display device;
detecting a navigation input for traversing a path of nodes in the hierarchy including a first path node and second path node, the path determined based on the start node;
in response to detecting the navigation input, traversing the path including sending first path representation information representing the first path node for presenting, based on the first path representation information, a first path visual representation of the first path node by the display device in place of the start visual representation; and
automatically sending second path representation information representing the second path node for presenting, based on the second path representation information, a second path visual representation of the second path node by the display device in place of the first path visual representation.

21. A system for traversing nodes in path on a display device, the system comprising:
means for detecting a first navigation input from a user;
means for determining a first path including a first plurality of nodes in a hierarchy; and
means for in response to the first navigation input, traversing the first path by providing for sequentially presenting in time, by a display device, first visual representations of the nodes in the first path, the first visual representations indicating corresponding current locations during the traversing.

22. A system for traversing nodes in path on a display device, the system comprising:
a navigation controller component configured for detecting a first navigation input from a user;
a path selector component configured for determining a first path including a first plurality of nodes in a hierarchy; and
a node user interface element handler component configured for in response to the first navigation input, traversing the first path by providing for sequentially presenting in time, by a display device, first visual representations of the nodes in the first path, the first visual representations indicating corresponding current locations during the traversing.

23. A system for traversing nodes in path on a display device, the system comprising:
means for sending start representation information representing a start node, included in a hierarchy of nodes, for presenting, based on the start representation information, a start visual representation of the start node by a display device;
means for detecting a navigation input for traversing a path of nodes in the hierarchy including a first path node and second path node, the path determined based on the start node;
means for in response to detecting the navigation input, traversing the path including sending first path representation information representing the first path node for presenting, based on the first path representation information, a first path visual representation of the first path node by the display device in place of the start visual representation; and
means for automatically sending second path representation information representing the second path node for presenting, based on the second path representation information, a second path visual representation of the second path node by the display device in place of the first path visual representation.

24. A system for traversing nodes in path on a display device, the system comprising:
a node user interface element handler component configured for sending start representation information representing a start node, included in a hierarchy of nodes, for presenting, based on the start representation information, a start visual representation of the start node by a display device;
a navigation controller component configured for detecting a navigation input for traversing a path of nodes in the hierarchy including a first path node and second path node, the path determined based on the start node;
a path selector component configured for in response to detecting the navigation input, traversing the path including sending first path representation information representing the first path node for presenting, based on the first path representation information, a first path visual represention of the first path node by the display device in place of the start visual representation;
a path selector component configured for automatically sending second path representation information representing the second path node for presenting, based on the second path representation information, a second path visual representation of the second path node by the display device in place of the first path visual representation.

25. A computer readable medium embodying a computer program, executable by a machine, for traversing nodes in path on a display device, the computer program comprising executable instructions for:
detecting a first navigation input from a user;
determining a first path including a first plurality of nodes in a hierarchy; and
in response to the first navigation input, traversing the first path by providing for sequentially presenting in time, by a display device, first visual representations of the nodes in the first path, the first visual representations indicating corresponding current locations during the traversing.

26. A computer readable medium embodying a computer program, executable by a machine, for traversing nodes in path on a display device, the computer program comprising executable instructions for:
sending start representation information representing a start node, included in a hierarchy of nodes, for presenting, based on the start representation information, a start visual representation of the start node by a display device;
detecting a navigation input for traversing a path of nodes in the hierarchy including a first path node and second path node, the path determined based on the start node;
in response to detecting the navigation input, traversing the path including sending first path representation information representing the first path node for presenting, based on the first path representation information, a first path visual representation of the first path node by the display device in place of the start visual representation; and
automatically sending second path representation information representing the second path node for presenting, based on the second path representation information, a second path visual representation of the second path node by the display device in place of the first path visual representation.
